(19) United States
(12) Patent Application Publication
(10) Pub. No.: US 2004/0110101 A1
(43) Pub. Date: Jun. 10, 2004

(54) Photographic processing

(75) Inventor: John R. Fyson, Hackney (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/712,658

(22) Filed: Nov. 13, 2003

(30) Foreign Application Priority Data
Dec. 5, 2002 (GB) 0228356.2

(51) Int. Cl. G03C 7/407; G03C 5/29

(52) U.S. Cl. 430/434; 430/493

(57) ABSTRACT

The invention provides a method of photographic processing, comprising the step of applying a photographic processing solution to the surface of a photographic material, wherein the surface tension of the processing solution is controlled to be between about 40 and about 50 dyne/cm.

### CROSS-REFERENCE TO RELATED APPLICATION

This is a U.S. Original Patent Application which claims priority on United Kingdom Patent Application No. 0228356.2 filed Dec. 5, 2002.

### FIELD OF THE INVENTION

This invention relates to processing photographic materials and in particular the application of processing solutions to the surface of photographic materials such as photographic paper or film.

### BACKGROUND OF THE INVENTION

Photographic processing is usually carried out in a number of tanks inside a photographic processor. Material to be processed is passed through successive tanks within the processor, the tanks containing processing chemicals or solutions. For a paper process there would typically be a tank containing each of developer, bleach-fix and a washing or stabilising solution. A drier would be provided to receive and dry the processed paper

Recently there have been moves to make photographic processors smaller without tanks, the processing solutions being applied directly to the surface of the material using an appropriate applicator. Examples of suitable application methods include the use of rollers or blades or alternatively spraying or inkjetting of the processing solution onto the surface of the photographic material. The metered application of fresh processing chemicals means that each piece of photographic material sees the same chemistry and is not subject to any previous processing history. This removes the need for constant process control, as there should be no change in processing solution constitution. This also removes the need for maintaining constant composition of the processing solutions by replenishment or other means and accordingly replenishment pumps are no longer needed. Furthermore, since there are no tanks, no recirculation of processing solutions is required and consequently no means of recirculation e.g. recirculation pumps are needed. This reduces the overall number of pumps used in the processor since only a metering pump is required to apply the solution in some manner to the surface of the photographic material.

Single use of a processing solution also allows the use of unstable chemistry to carry out the processing steps, as two or more stable parts of a processing solution can be brought together immediately before application, or on the surface of the material being processed. The unstable chemistries that might be used are a Redox amplifying developer or a peroxide bleach, as described in our co-pending U.K. Patent Application 0228355.4 entitled “Photographic Processing”. This application relates to a method of applying processing solution to the surface of photographic material to be processed.

One way to carry out single use processing, is to jet the processing solutions though an air gap onto the surface of the photographic material as a series of droplets applied evenly across the surface of the photographic material. A suitable system for operating in this manner is described in European Patent Applications EP 1046953A1 and EP 0984324A1 both in the name of Konica Corporation. The material to be processed is covered in drops to create an even layer of processing solution. The solution is left on the material for sufficient time for the process to complete before continuing with the process. Subsequently, further processing solutions may be applied by any of the application methods mentioned above or by using conventional tank processing.

One of the advantages of jetting liquid onto the surface of photographic material is that the jetted liquid is associated with only a small area of the photographic material, approximately equal to the size of a spread-out droplet, plus the area covered by a small amount of sideways diffusion of the applied solution. This means that the influence of a neighbouring area of photographic material on the processing solution is insignificant. Accordingly, there is no seasoning effect of one point of the material on an adjacent one and so ‘drag’ effects from seasoning are therefore minimised.

The metered application to the surface also allows the possibility of applying the processing solution image-wise to reduce the amount of solution required as described in our co-pending European Patent Application No. EP 02010819.7.

It is hoped that a jet application system will allow the production of border-less, one-off prints on photographic paper. This will require solution to be jetted up to and a little over the paper edge. The jetting position and paper transport system will allow the drops of solution to miss surfaces which need to be kept clean such as a platen used to support the material during application of the solution. However, in order to get even development (i.e. predictable development such that any two regions within the image of a common image density experience the same amount of development) across the photographic material, the processing solutions e.g. developer have to be laid down to form a continuous layer, either of a uniform thickness over the image if uniform application of processing solution is being used or of some predetermined threshold thickness required for the particular image density of a particular image region if image-wise application of processing solutions is being used.

It is known that surfactants may be used to control the surface tension of a processing solution and enable the formation of a stable, uniform layer of processing solution. To control the creation of a uniform layer of processing solution it is necessary to ensure that droplets of processing solution emerge through the orifices from which they are jetted without leaving remnants of the droplet ligaments behind. In other words, the affinity of the processing solution for the orifice surfaces must be sufficiently low. To achieve this surfactants are added to the solution so that surface tension of the solution is low. European Patent Application No. EP 0984324A1 in the name of Konica, suggests adding surfactants to a processing solution to control surface tension so that an even uniform layer of solution is formed.

### PROBLEM TO BE SOLVED BY THE INVENTION

The wetting angle of the processing solutions on the surface of the photographic material, (the emulsion surface) is less than 900 for a wetting surface. The thickness of the layer of processing solution at the edge of the paper rises from zero at the edge to the thickness of the uniform layer over a short distance. Accordingly, there is an uneven distribution of chemistry near the edge of the photographic material causing a variation e.g. a reduction, in image density at the corresponding positions in the image.

The higher the wetting angle the faster the liquid levels out and the narrower the region of low density, resulting from inadequate supply of chemistry, becomes. This is illustrated in FIG. 1B which shows the variation of the thickness of the layer of processing solution with distance from paper edge. Such a variation in thickness can lead to corresponding variations in image density in the regions where the thickness varies. This can lead to unacceptable variations in image quality such that the photographic material from these regions must be discarded. This is wasteful and clearly undesirable.

When processing solution is initially applied to the surface of the photographic material the thickness of the layer of solution does not vary substantially. The settling of the solution into a layer having a low wetting angle as shown in FIG. 1B is a dynamic process in which the solution flows away from the edge and can be seen to flow towards point at which droplets of solution initially impinge on the surface of the photographic material. The movement of the liquid causes drag lines and severe edge effects often extending over several millimetres. This is clearly undesirable.

### SUMMARY OF THE INVENTION

According to the present invention there is provided a method of photographic processing, comprising the step of applying a photographic processing solution to the surface of a photographic material, wherein the surface tension of the processing solution is controlled to be between about 40 and about 50 dyne/cm.

### ADVANTAGEOUS EFFECT OF THE INVENTION

The present invention provides a method of photographic processing in which processing solution is applied to the surface of photographic material, wherein the surface tension of the solution e.g. developer being applied is controlled such that it falls between 40 and 50 dyne/cm. By controlling the surface tension of the processing solution to within this narrow range of values it is possible to ensure that the wetting angle is sufficiently large such that the density fall-off at the edge of the paper is not noticeable to an untrained eye.

Using the method of the present invention, it is also possible to ensure that, starting from the edge of the paper, the thickness of the layer of processing solution rises to the required threshold level over a smaller distance than was previously possible. Wastage of photographic material is therefore reduced since images can be printed closer to the edge of the material without suffering unacceptable variation in local image quality than was previously possible.

### BRIEF DESCRIPTION OF THE DRAWINGS

Examples of the present invention will now be described in detail with reference to the accompanying drawings, in which:

FIG. 1A shows a schematic representation of a section through photographic material coated with a processing solution using a method according to the present invention;

FIG. 1B shows a schematic representation of a section through photographic material coated with a processing solution using a conventional processing method;

FIG. 2 shows a schematic representation of a side elevation of an apparatus suitable for performing the method of the present invention;

FIG. 3 shows a schematic representation of a plan view of an apparatus according suitable for performing the method of the present invention; and

FIG. 4 is a graph showing the variation of image density with distance from the edge of an image developed using a number of different developer solutions.

### DETAILED DESCRIPTION OF THE INVENTION

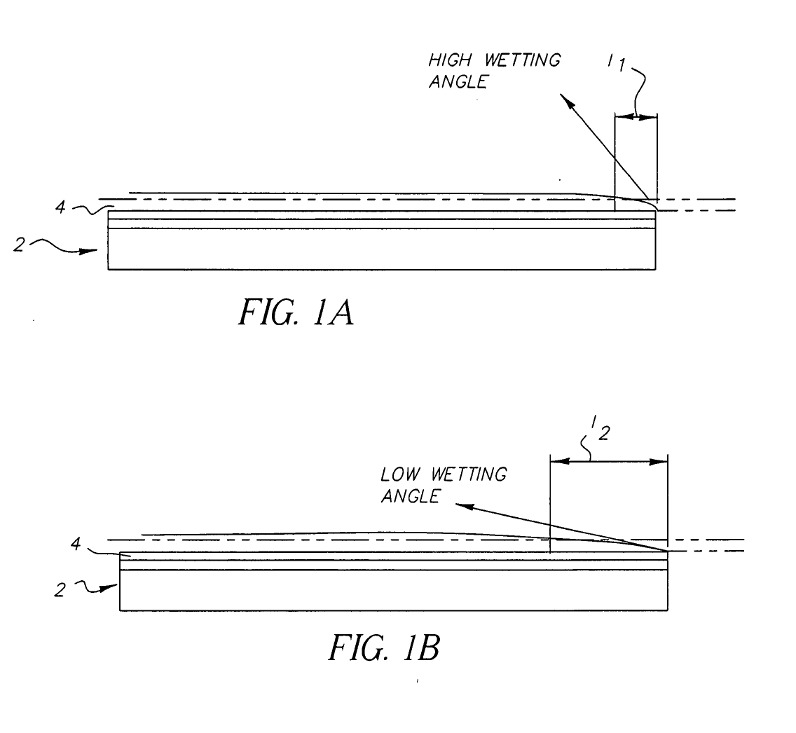

FIG. 1A shows a schematic representation of a section through photographic material 2 coated with a layer 4 of processing solution using a method according to the present invention. FIG. 1B also shows a schematic representation of a section through coated photographic material 2, although in this case the material 2 has been coated with a processing solution using a conventional processing method. The distances l₁ and l₂ in FIGS. 1A and 1B respectively are the distances from the edge of the photographic material that it takes the thickness of the layer of processing solution to increase to a value equal to a threshold thickness required for invisible image density loss. It can be seen that the distance l₁ is substantially less than the distance l₂.

According to the present invention, processing solution having a surface tension within the range 40 to 50 dyne/cm is used such that the distance it takes for the thickness of the layer of processing solution to rise to the threshold thickness is minimised.

The photographic material in the strip having an area equal to l₁ in FIG. 1A or l₂ in FIG. 1B multiplied by the length of the material, is wasted since image information is not printed here since the image density is unreliable. Accordingly, when the method of the present invention is used there is a correspondingly smaller amount of material wasted than when conventional surface application processing is used. When the method of the present is used it is possible to print an image right up to the position l₁ mm from the edge of the material.

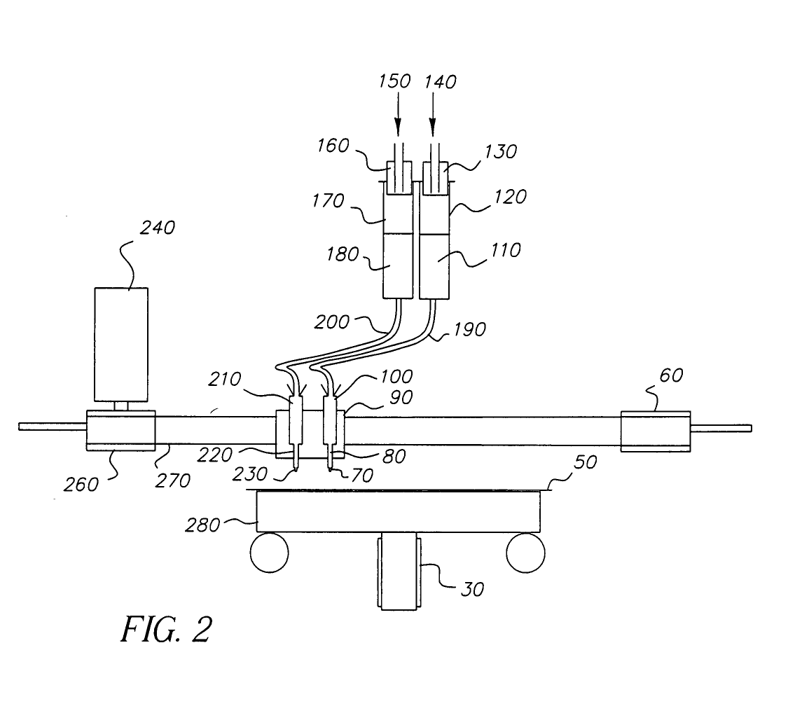

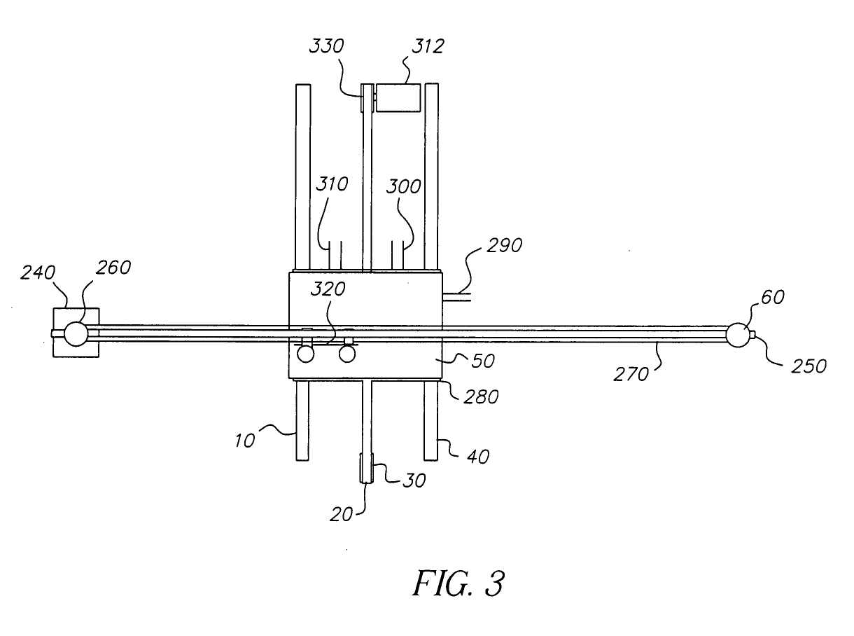

FIGS. 2 and 3 show respectively a schematic representation of a side elevation and a plan view of an apparatus suitable for performing the method according to the present invention for applying processing solution to the surface of photographic material. The apparatus is driven by an electrical power source coupled to electrical connections which are not shown.

The apparatus comprises a receiver e.g. a platen 280, driven relative to an assembly 320 of optionally moveable sources of processing solution. The platen 280 is adapted to receive a piece of photographic material to be processed by the processing solution. Each of the sources is arranged to provide a processing solution to the surface of the photographic material.

The platen 280 and moveable sources 320 of the processing solution are configured such that processing solution may be applied to any desired position on the platen 280. One way in which this may be achieved is by configuring the platen 280 and sources to move in mutually perpendicular directions in closely arranged parallel planes. As the assembly 320 and sources move relative to the platen the sources are controlled, either simultaneously or in sequence, to eject their respective processing solution onto the photographic material. It is possible that only a single source of processing solution is provided or where more than one is provided the same solution is used in both or all of them.

In the example shown the size of the platen 280 is 150×125 mm, and it is heated by tempered water passing through connections 300 and 310. The platen 280 is driven under the assembly 320 by a drive system in this case comprising a belt 20, pulleys 30 and 330 and a stepper motor 310. The platen 280 is coupled to guide rails 10 and 40 shown in FIG. 3. The stepper motor 310 is driven from a control box which is in turn controlled by a computer (not shown).

As explained above the jet assembly comprises at least one source of processing solution. In the example shown the jet assembly 320 consists of two mounted sapphire orifices with holes 70 and 230 having a diameter of 75 microns. The holes 70 and 230 are connected to two fast acting solenoid valves 100 and 210 by silicone rubber tubes 80 and 220, respectively. Each of the solenoid valves 100 and 210 includes an inlet 140 and 150, connected respectively to gas-powered syringes 120 and 170 again by means of flexible silicone rubber tubes 190 and 200. Inlets 140 and 150 are coupled to the syringes. Pressurised gas such as compressed air is fed through the inlets to drive the syringes to output processing solution.

In use, prior to operation of the apparatus, the syringes 120 and 170 are filled with a selected processing solution. The platen and/or the assembly are moved relative to the assembly 320, in accordance with a predetermined pattern, whilst simultaneously processing solutions are jetted as droplets from the syringes 120 and 170. In one example, the platen and assembly are controlled to move in a pattern such that all positions on the photographic material may be covered by a uniform layer of processing solution. The syringes can be controlled to output more or less solution in dependence on image information. Alternatively, the platen and the assembly can be moved relative to each other in accordance with image information.

As explained above, the assembly 320 is driven in a direction perpendicular and in a plane parallel to the platen movement. A drive system comprising a stepper motor 240 coupled to a belt 270 around pulleys 60 and 260 may be used. In the example shown, the jetting is stimulated by application of a suitable electrical pulse to the solenoid valves 100 and 210. This pulse is generated by means of a pulse shaper (not shown). The pulse length and timing may be controlled by means of the same computer controlling the movement of the platen and the jet assembly 320.

Optionally, a single nozzle opening 114 may be used to output processing solution. In this case, a connection 112 may be provided between the holes 70 and 230 to enable mixing of the processing solution stored in each of the syringes occurs immediately prior to application of the solution to the photographic material.

A computer program run on a computer controls the process of application of processing solution. The position and movement of the platen 280 relative to the jet assembly 320 is controlled by arranging the apparatus in a predefined position determined by detection using microswitches, not shown in the diagrams. Typically, the microswitches are arranged such that when the platen has moved to a predetermined position the switches are caused to engage. This defines a position with reference to which subsequent movement of the platen 280 can be controlled. The microswitches provide a means of defining a reference position against which subsequent movement of the platen 280 can be controlled. Other suitable means for defining such a position may also be used e.g. an optical position sensor or a mechanical stop.

The jet assembly 320 and platen 280 is then moved so that one corner of a piece of paper, held on the heated platen 280 by means of vacuum supplied via inlet 290 is under orifice 230. The jet assembly 320 is moved about 1 mm by pulses sent to the stepper motor 240 and a pulse is sent to the solenoid valve 210 so that a drop of the processing solution is fired on to the paper. The jet assembly 320 is then advanced until a line of drops has been fired at the paper. As explained above, the surface tension of the processing solution fired is controlled so that the drops just overlap and a uniform layer of processing solution is formed on the surface of the photographic material. At the end of the paper the platen is advanced about 1 mm and a line of drops is written to the paper in the opposite direction to the first line. This process is completed when the platen has travelled far enough to ensure that the entire surface of the paper has been coated with the processing solution.

### EXAMPLES

The invention will be exemplified by the following examples:

### Example 1

Apparatus was built according to FIGS. 2 and 3.

The air pressure to the syringes was set at 0.65 bar and the pulse length to open the valves 100 and 210 of 0.5 ms. With this set up the formulae that follow gave a laydown of approximately 65 ml/m² for each of the processing solutions used. The platen was heated to 40° C. with circulating water.

To test the effect of different surfactants on edge wetting, even coverage and jetting, a developer was made up with the following composition.

| | | |
|---|---|---|
| BD89 | 10 | g |
| CD3 | 10 | g |
| K2CO3 | 30 | g |
| KOH | 0.4 | g |
| Water to | 1 | litre |
| pH 12.3 (adjusted with 30% nitric acid) | | |

A number of different surfactants and combinations of surfactants were added to this developer as shown in Table 1 below. A stop solution was prepared as follows:

| Stop | | |
|---|---|---|
| acetic acid glacial | 100 | ml |
| Silwet L-7607 (TM Witco Chemical Co.) | 4 | g |
| water to | 1 | litre |

Syringes 170 and 120 were charged with Developer 3 and Stop respectively.

A visual assessment was made of the developers and is shown in Table 1. The surface tensions of these developers were measured and the results are shown in Table 2.

Inspection of the results shows that the developers that have even coverage have surface tension of <47 dyne/cm. For a developer not to pull away from the cut edge the surface tension must be >40 dyne/cm in the system tested.

TABLE 1

| ID | Silwet | Tween 80 | Other | Amount | Comment |
|---|---|---|---|---|---|
| 111 | 4 g/l | — | — | — | pulled off front low |
| | | | | | density edge |
| 112 | 6 g/l | — | — | — | pulled off front low |
| | | | | | density edge |
| 113 | — | 4 g/l | — | — | wet front - not |
| | | | | | even cover |
| | | | | | some sign of |
| | | | | | repellency |
| 114 | — | 8 g/l | — | — | wet front - no |
| | | | | | even cover, bad |
| | | | | | tendency to block |
| | | | | | jet? some sign |
| | | | | | of repellency |
| 115 | 4 g/l | 4 g/l | | | almost wet front |
| | | | | | properly, not quite |
| | | | | | even coverage, |
| | | | | | some tendency to |
| | | | | | block jet? |
| 116 | | | Aerosol | 4 g/l | uneven cover |
| | | | | | surfactant |
| | | | TR70 | | precipitated on |
| | | | | | standing |
| 117 | 4 g/l | — | poly- | 100 g/l | even cover no |
| | | | acrylic | | light edge |
| | | | acid 5,100 | | precipitated on |
| | | | | | standing |
| 118 | 0.7 g/l | 3.3 g/l | — | — | wet front, not |
| | | | | | quite even, might be |
| | | | | | some blocking |
| | | | | | tendency |
| 119 | 2 g/l | 2 g/l | | | slight tendency to |
| | | | | | repel - not bad |
| 120 | — | — | FT248 | 2 g/l | even cover no |
| | | | | | light edge |
| 121 | 2 g/l | | Ft 248 | 2 g/l | even cover no |
| | | | (PE1119 | | light edge |
| 122 | — | — | Zonyl | 2 g/l | uneven coverage |
| | | | FSN | | |
| 123 | | | LODYNE | 2 g/l | good coating but |
| | | | | | surface like orange |
| | | | | | peel at first - took |
| | | | | | about 10-15s to |
| | | | | | even out |
| 124 | 0.2 ish | | FT248 | 2 g/l | even cover |
| | | | | | no light edge |

TABLE 2

| | Surface |
|---|---|
| Developer | Tension |
| Number | (dyne/cm) |
| 111 | 38.8 |
| 112 | 36.1 |
| 113 | 62.4 |
| 114 | 59.7 |
| 115 | 47.2 |
| 116 | 54.1 |
| 117 | 43.0 |
| 118 | 49.9 |
| 119 | 47.2 |
| 120 | 40.2 |
| 121 | 44.4 |
| 122 | 51.3 |
| 123 | 51.3 |

### Example 2

A quantitative approach was taken for some of the developers. The image developed in the light was scanned at 300 dpi on ScanMaker E6 flatbed scanner. A small area of the edge about 40×160 pixels was sub-sampled and stored as a .RAW file—a filed of the raw digital data. The long dimension was in the direction of movement of the jet. This file was read into an Excel worksheet a simple macro (RAW filename in A1, width in A4 and length in A7):

The byte data was then converted into densities by:

D=empirical scaling factor.log₁₀(byte value/255)

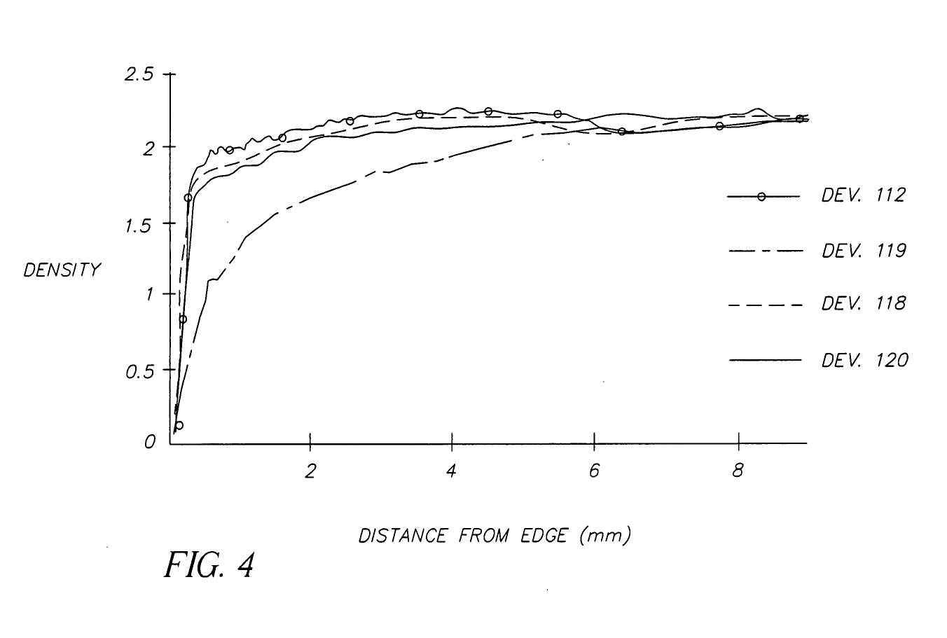

The densities were averages across the short dimension so that variations across the width of the sample were averaged out. The long dimension showed the density change from the edge. The results are plotted in the graph of FIG. 4.

The graph shows the slow rise in density of the image developed using a developer with low surface tension (dev. 112) in contrast to the rise in density of images developed using developer with higher surface tensions (developers 118, 119 and 120). It can be seen that when a developer is used having a surface tension lower than 40 dyne/cm (developer 112 has a surface tension of 36.1 dyne/cm) there is a variation in image density at the edge of the paper due to the effects described above. Such a variation in image density is visible to the human eye. Similarly, when a developer is used having a surface tension higher than 50 dyne/cm coverage of the photographic is uneven leading to unevenness in the image.

What is claimed is:

1. A method of photographic processing, comprising the step of:
applying a photographic processing solution to the surface of a photographic material, wherein the surface tension of the processing solution is controlled to be between about 40 and about 50 dyne/cm.

2. A method according to claim 1, wherein the processing solution is a photographic developer solution.

3. A method according to claim 1, wherein the surface tension of the processing solution is controlled by the addition of one or more surfactants thereto.
